(19) United States
(12) Patent Application Publication
(10) Pub. No.: US 2003/0108210 A1
(43) Pub. Date: Jun. 12, 2003

(54) Vechicle having loudspeaker

(76) Inventors: Jurgen Dreyer, Schafheim (DE); Rolf Janke, Kiel (DE); Heiko Schnieders, Schafheim (DE); Michael Hein, Revensdorf (DE); Winfried Moll, Laubach (DE)

Correspondence Address: Martin A. Farber, Suite 473, 86 United Nations Plaza, New York, NY, 10017, US

(21) Appl. No.: 10/235,744

(22) Filed: Sep. 4, 2002

(30) Foreign Application Priority Data
Sep. 11, 2001 (DE) 101 44 786.8

(51) Int. Cl. H04B 1/00; H04R 5/02

(52) U.S. Cl. 381/86; 381/302; 381/389

(57) ABSTRACT

The invention relates to a vehicle (1) having a loudspeaker (9) for emitting sound waves (10, 11) into a passenger compartment (2) and having an air duct (7) for the air conditioning of the passenger compartment (2), the air duct (7) having an air duct opening (6) which faces the passenger compartment (2). In order to reduce the installation space for the loudspeaker (9), the invention proposes that the loudspeaker (9) is arranged in the air duct (7) in such a manner that the sound waves (10, 11) can be emitted through the air duct opening (6) into the passenger compartment (2).

The invention relates to a vehicle having a loudspeaker for emitting sound waves into a passenger compartment and having an air duct for the air conditioning of the passenger compartment, the air duct having an air duct opening which faces the passenger compartment.

Vehicles of this type are known, for example, as watercraft or aircraft, but in particular as motor vehicles. A loudspeaker serving as part of an audio system for the acoustic irradiation of the passenger compartment is provided. The passenger compartment may be either essentially closed or open to the outside—such as, for example, in the case of a convertible. Furthermore, it is customary in such vehicles to provide air ducts for air conditioning, i.e. for ventilating and/or for heating and/or cooling the passenger compartment. Particularly in the cockpit region of the vehicle, these air ducts have air duct openings through which air can be conveyed into the passenger compartment and/or interior air can be conveyed out of the passenger compartment into the air duct.

A disadvantage of the known vehicles is that the installation space for loudspeakers is very limited. In the cockpit region, in particular, only a very small amount of installation space is available for the loudspeakers owing to a multiplicity of devices to be arranged, such as display instruments, climate control devices, storage compartments, air ducts and air outlet openings. Therefore, if any loudspeakers at all are installed in the cockpit, they are only small with weak sound, and, if appropriate, loudspeakers are arranged in the vehicle doors where somewhat more installation space is available. However, the installation of loudspeakers in doors involves further disadvantages, such as sound problems and a necessity of a special seal against moisture.

It is known from DE 196 54 416 C1 to provide a cover for the interior of a motor vehicle having a grid-like surface which is provided with passages in at least one subregion, it being possible to insert the cover into an interior paneling or into an instrument panel, and the subregion having passages covering an opening of an airline running in or behind the interior paneling or the instrument panel. This cover is formed in such a manner that at least one further subregion of the grid-like surface with passages is provided, which subregion covers a loudspeaker arranged in a recess of the interior paneling or of the instrument panel. Although different devices can therefore be combined in a space-saving manner, it is disadvantageously also not possible for this cover to enlarge the installation space available for the loudspeaker.

The invention is therefore based on the object of providing a vehicle of the type mentioned at the beginning which has a loudspeaker, in particular in a cockpit region, an additional, dedicated installation space not having to be made available for the loudspeaker.

This object is achieved according to the invention by the fact that the loudspeaker is arranged in the air duct in such a manner that the sound waves can be emitted through the air duct opening into the passenger compartment.

Owing to such a construction, the loudspeaker is arranged in a dead vehicle region which cannot otherwise be used. The characteristic feature of the three-dimensional radiation of sound waves by a loudspeaker is made use of here, the sound waves being channeled, conveyed in the air duct and emitted into the passenger compartment. It is of further advantage here that the loudspeaker in the air duct has air flowing around it, as a result of which overheating of the loudspeaker can be avoided. In addition, a reduction in weight of the vehicle results, since costly retaining and covering frames for the loudspeaker are not required. In addition, the installation of additional covering grids, as are required according to the prior art in front of loudspeakers in order to protect them from mechanical damage, can be omitted. In addition, loudspeakers which are exposed to environment effects in passenger compartments, for example of convertibles, are advantageously particularly protected by the installation in the air duct. Owing to the use of the volume of the air duct as a resonance space for the loudspeaker, good acoustic characteristics of the sound reproduction advantageously arise.

Any loudspeakers, for example even broadband loudspeakers, can be used as loudspeakers for reproducing essentially the entire frequency spectrum audible for humans. However, according to an advantageous development of the invention, the loudspeaker is a low frequency loudspeaker, as a result of which the resonance space which is available in the air duct can be used particularly effectively and a particularly high quality of sound is achieved.

Particularly when a low frequency loudspeaker is used, it is of particular advantage, according to another development of the invention, if the air duct opening is arranged in a footwell of the passenger compartment. Low frequencies are not locatable for the human ear; loudspeakers radiating such frequencies can therefore be arranged freely. An arrangement of the corresponding air duct openings in the footwell permits a particularly protected loudspeaker installation and the use of installation regions which can hardly be used for other devices.

According to another advantageous development of the invention, the loudspeaker is arranged in the air duct in such a manner that sound waves can additionally be emitted directly into the passenger compartment. In this manner, sound reproduction with particularly high quality of sound is obtained. Especially when a low frequency loudspeaker is used, an improvement in sound can therefore be achieved owing to the acoustic short circuit in the passenger compartment, which is not critical at low frequencies. The loudspeaker can be arranged, for example, in a region of an air duct inner wall leading into the passenger compartment.

The acoustic quality of the loudspeaker is directly influenced by the resonance behavior arising in the air duct volume. It is advantageous, particularly in the case of freely shaped air ducts, if a volume element for the acoustic tuning of the loudspeaker is arranged in the air duct. This volume element, which is preferably bonded onto the air duct inner wall and is, for example, a hollow plastic body or a foam element, can be placed in such a manner that—depending on the respective type of vehicle and/or on a special design of the air duct—an optimization of sound is achieved.

In principle, the air duct can be arranged at any point of the passenger compartment of the vehicle. However, according to an advantageous development of the invention, the air duct with the air duct opening and the loudspeaker is arranged in a cockpit element, as a result of which particularly spacious volumes of the air duct are available as a resonance space. The cockpit element may, for example, be an instrument panel, in particular an instrument panel covering.

The vehicle assembly is further simplified if the air duct is connected to the cockpit element forming a single component, as a result of which a particularly low number of components arises.

The production of the air duct and therefore also the vehicle is particularly cost-effective and simple if the air duct is a blown plastic component. An integration of the air duct in other installation parts of the passenger compartment, for example in the cockpit element, can therefore be achieved in a particularly simple manner.

The invention will be explained in greater detail below with reference to exemplary embodiments illustrated in the attached drawing, in which:

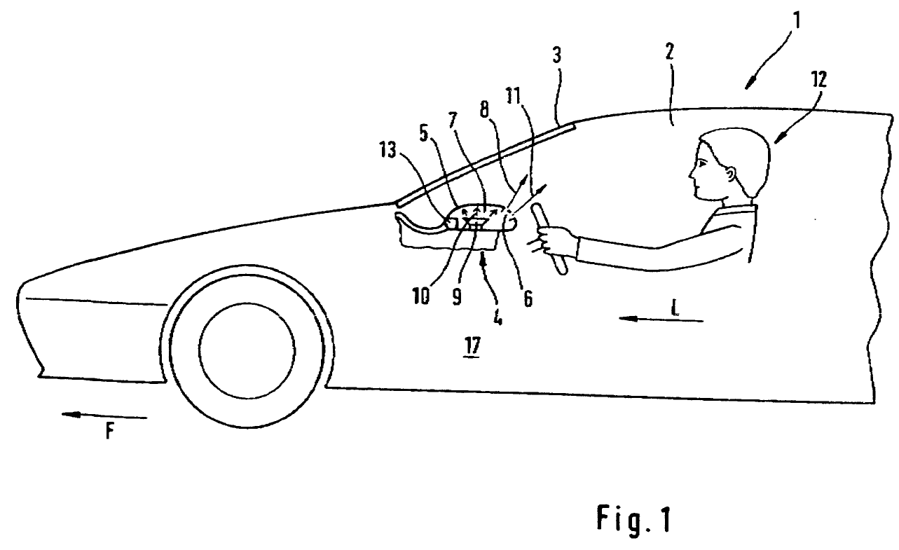

FIG. 1 shows a partial section of a vehicle having a loudspeaker and an air duct,

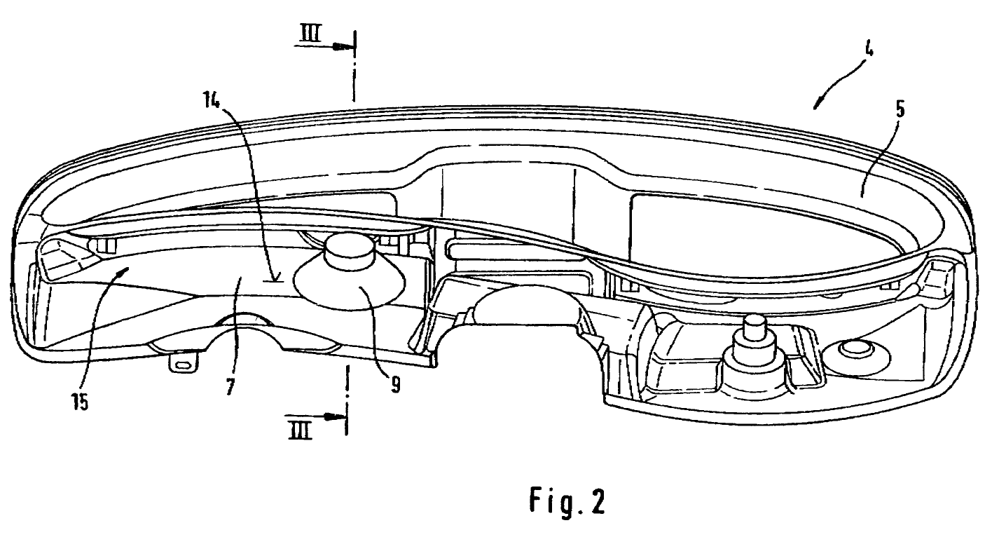

FIG. 2 shows a cockpit element having a loudspeaker in a perspective view, and

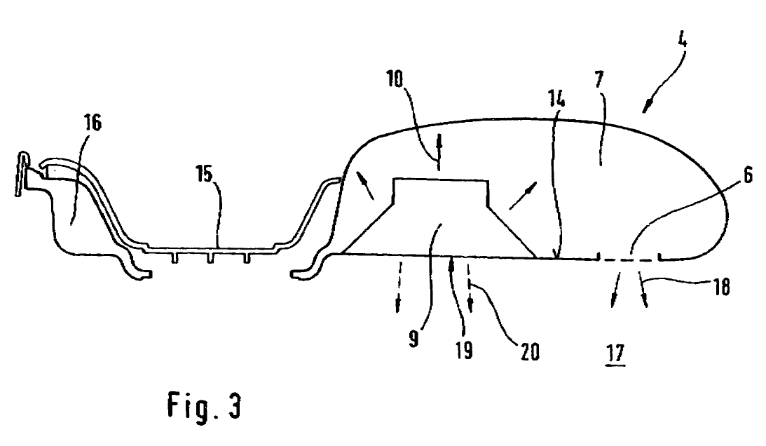

FIG. 3 shows a section along the line III-III through the cockpit element according to FIG. 2.

Corresponding elements are in each case provided with the same reference numbers in the figures.

In FIG. 1, in a stylized partial section, a motor vehicle 1 having a passenger compartment 2, which has a footwell 17, and having a windscreen 3 is illustrated. Among other things, a cockpit element, which is formed by an instrument panel 4, only part of which is shown here, is arranged in the passenger compartment 2. The instrument panel 4 has an instrument panel covering 5.

The instrument panel covering 5, which is an elongate component and extends approximately in the transverse direction of the motor vehicle 1, has an air duct 7 connected to an air duct opening 6. The air duct opening 6 faces the passenger compartment 2, so that air—indicated by an arrow 8—can pass through it from the air duct 7 into the passenger compartment 2.

In addition, a loudspeaker 9 for emitting sound waves, which are indicated by arrows 10, is arranged in the air duct 7, which is constructed as a blown plastic component. The sound waves emitted by the loudspeaker 9 enter—indicated by an arrow 11—through the air duct opening 6 into the passenger compartment 2. In this manner, the sound waves (arrows 10, 11) emitted by the loudspeaker 9 can be perceived by a vehicle occupant 12.

Arranged in the air duct 7, for the acoustic tuning of the loudspeaker 9, is a volume element 13 influencing the resonance of the air duct 7.

In FIG. 2, a cockpit element constructed as an instrument panel 4 and similar to FIG. 1 is illustrated enlarged and in a perspective view approximately in the direction L of the longitudinal axis of the vehicle (cf. FIG. 1). The air duct 7 extends approximately over the entire width of the instrument panel 4 (i.e. approximately over the entire width of the passenger compartment) and is essentially formed by its outer walls, to which the instrument panel covering 5 also belongs. A loudspeaker 9 is arranged on an air duct inner wall 14, in a region 15 of the air duct 7 on the left in the direction of travel F (cf. FIG. 1). The loudspeaker 9 is bonded to the air duct inner wall 14.

An enlarged section through the instrument panel 4 along the line III-III from FIG. 2 is reproduced in FIG. 3. It can be seen therein that the instrument panel 4 has in addition to the air duct 7 an oddments tray 15 and a retaining edge 16, among other things. The loudspeaker 9, which is arranged on the air duct inner wall 14, emits sound waves, indicated by arrows 10, into the air duct 7. The sound waves (arrows 10) emitted by the loudspeaker 9 enter, indicated by arrows 18, into the passenger compartment through an air duct opening 6 arranged in a footwell 17 (cf. also FIG. 1) of a passenger compartment (not illustrated further here). In addition, the air duct inner wall 14 can have, in a passage region 19 assigned to the loudspeaker 9, a recess for the passage, directly into the footwell 17, of sound waves—illustrated by dashed lines 20—which are emitted by the loudspeaker 9. The acoustic short circuit which arises as a result between the sound waves (arrows 18) entering the footwell 17 through the air duct opening 6 and the sound waves (dashed arrows 20) entering the footwell 17 directly through the recess in the passage region 19 of the air duct inner wall 14 is not critical, in particular at low frequencies, so that a low frequency loudspeaker is especially suitable as the loudspeaker 9 in this embodiment.

1. A vehicle (1) having a loudspeaker (9) for emitting sound waves (10, 11) into a passenger compartment (2) and having an air duct (7) for the air conditioning of the passenger compartment (2), the air duct (7) having an air duct opening (6) facing the passenger compartment (2), characterized by the fact that the loudspeaker (9) is arranged in the air duct (7) in such a manner that the sound waves (10, 11) can be emitted through the air duct opening (6) into the passenger compartment (2).

2. The vehicle as claimed in claim 1, characterized by the fact that the loudspeaker (7) is a low frequency loudspeaker.

3. The vehicle as claimed in claim 1 or 2, characterized by the fact that the air duct opening (6) is arranged in a footwell (17) of the passenger compartment (2).

4. The vehicle as claimed in one of the preceding claims, characterized by the fact that the loudspeaker (9) is arranged in the air duct (7) in such a manner that sound waves can additionally be emitted directly into the passenger compartment (2).

5. The vehicle as claimed in one of the preceding claims, characterized by the fact that a volume element (13) for the acoustic tuning of the loudspeaker (9) is arranged in the air duct (7).

6. The vehicle as claimed in one of the preceding claims, characterized by the fact that the air duct (7) is arranged with the air duct opening (6) and the loudspeaker (9) in a cockpit element (4; 5).

7. The vehicle as claimed in claim 6, characterized by the fact that the air duct (7) is connected to the cockpit element (4; 5) forming a single component.

8. The vehicle as claimed in one of the preceding claims, characterized by the fact that the air duct (7) is a blown plastic component.
